(19) United States
(12) Patent Application Publication
(10) Pub. No.: US 2007/0179015 A1
(43) Pub. Date: Aug. 2, 2007

(54) Power system

(75) Inventors: Kris William Johnson, Peoria, IL (US); William Henry Lane, Chillicothe, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/342,529

(22) Filed: Jan. 31, 2006

(51) Int. Cl. H02P 15/00

(52) U.S. Cl. 477/8

(57) ABSTRACT

A power system has a prime mover. The power system may also include a multiple-ratio transmission having a rotary input member and a rotary output member. Additionally, the power system may include a coupler connected between the prime mover and the rotary input member of the multiple-ratio transmission. The power system may also include an electric machine. Additionally, the power system may include power-system controls operable to automatically control whether the rotary input member of the multiple-ratio transmission is drivingly connected to the prime mover, including automatically controlling whether the coupler has a power-transmitting operating state. The power-system controls may also be configured to operate the electric machine to reduce the speed of the prime mover in concert with an upshift of the multiple-ratio transmission.

### GOVERNMENT RIGHTS

This invention was made with Government support under the terms of Contract No. DE-FC04-2000AL67017 awarded by the Department of Energy. The Government may have certain rights in this invention.

### TECHNICAL FIELD

The present disclosure relates to power systems and, more particularly, to power systems having a prime mover and a multiple-ratio transmission.

### BACKGROUND

Many machines include a power load and a power system for driving the power load. The power system of many such machines includes a prime mover (such as an internal combustion engine) and a multiple-ratio transmission having a rotary input member and a rotary output member that is drivingly connected to the power load. When the rotary input member and the rotary output member of the multiple-ratio transmission are drivingly connected, the prime mover may drive the power load by driving the rotary input member of the multiple-ratio transmission. During such operation of the power system, the drive ratio between the rotary input member and the rotary output member of the multiple-ratio transmission may be selectively changed.

Generally, when the drive ratio of the multiple-ratio transmission is changed, power transfer between the prime mover and the power load through the multiple-ratio transmission is temporarily interrupted or reduced. In some cases, changing the drive ratio of the multiple-ratio transmission may require adjusting the operating speed of the prime mover before full power transmission is resumed. Unfortunately, the controls of the prime mover may only be capable of adjusting the speed of the prime mover relatively sluggishly. As a result, waiting on the controls of the prime mover to adjust its operating speed when the drive ratio of the multiple-ratio transmission is changed may cause power transfer through the multiple-ratio transmission to be interrupted or reduced for an undesirably long period.

U.S. Pat. No. 6,710,579 to Ebel et al. (“the '579 patent”) discloses utilizing a flywheel generator to expedite adjustment of the operating speed of an internal combustion engine when changing the drive ratio of a gearbox. The '579 patent discloses a propulsion system of a vehicle, the propulsion system having an internal combustion engine, a flywheel generator, and a gearbox. The propulsion system also includes a first clutch connected between the internal combustion engine and the flywheel generator. Additionally, the propulsion system includes a second clutch connected between the flywheel generator and an input shaft of the gearbox. The '579 patent discloses that the first clutch may be controlled manually or fully automatically.

The '579 patent teaches methods of coordinating control of the gearbox, the first clutch, and the flywheel generator during drive ratio changes of the gearbox. The '579 patent teaches that downshifts of the gearbox are executed with the first clutch engaged, and the flywheel generator may be operated to expedite increasing the operating speed of the internal combustion engine during downshifts. Additionally, the '579 patent discloses that, in configurations where the first clutch is manually controlled, upshifts of the gearbox are executed with the first clutch engaged, and the flywheel generator may be operated to reduce the operating speed of the input shaft of the gearbox during such upshifts.

The '579 patent also specifies that, in configurations where the first clutch is controlled automatically, upshifts of the gearbox are executed with the first clutch disengaged, and the flywheel generator operates to reduce the operating speed of the input shaft of the gearbox during such upshifts. With the first clutch disengaged, the flywheel generator is decoupled from the internal combustion engine during the upshift, and the flywheel generator does not affect the operating speed of the internal combustion engine.

The '579 patent also discloses methods of coordinating control of the internal combustion engine, the flywheel generator, the first clutch, the second clutch, and the gearbox to facilitate starting the internal combustion engine and, subsequently, launching the vehicle. The patent discloses causing the first clutch to be engaged while operating the flywheel generator to drive the internal combustion engine, so that the internal combustion engine may start. Simultaneously, the second clutch is caused to be disengaged, so that the flywheel generator does not propel the vehicle while the internal combustion engine is being started. After the internal combustion engine is started, the first clutch is disengaged and the flywheel generator is stopped. Subsequently, with the first clutch still disengaged, the second clutch is engaged. Finally, in order to propel the vehicle with power from the internal combustion engine, the first clutch is reengaged.

Although the '579 patent discloses utilizing a flywheel generator to expedite adjustment of the operating speed of an internal combustion engine during drive ratio changes of a gearbox, certain disadvantages persist. For example, for configurations where the first clutch is automatically controlled, the '579 patent teaches not utilizing the flywheel generator to expedite adjustment of the operating speed of the internal combustion engine when upshifting the gearbox. As discussed above, this may cause undesirably sluggish performance of the propulsion system when the gearbox is upshifted. Additionally, the complicated process of disengaging and reengaging the first and second clutches when starting the internal combustion engine and launching the vehicle may entail undesirable delays and risk of malfunction.

The power system and operating methods of the present disclosure solve one or more of the problems set forth above.

### SUMMARY OF THE INVENTION

One disclosed embodiment relates to a power system having a prime mover. The power system may also include a multiple-ratio transmission having a rotary input member and a rotary output member. Additionally, the power system may include a coupler connected between the prime mover and the rotary input member of the multiple-ratio transmission. The power system may also include an electric machine. Additionally, the power system may include power-system controls operable to automatically control whether the rotary input member of the multiple-ratio transmission is drivingly connected to the prime mover, including automatically controlling whether the coupler has a power-transmitting operating state. The power-system controls may also be configured to operate the electric machine to reduce the speed of the prime mover in concert with an upshift of the multiple-ratio transmission.

Another disclosed embodiment relates to a method of operating a mobile machine. The mobile machine may include a prime mover, an electric machine, a multiple-ratio transmission with a rotary input member and a rotary output member, one or more propulsion devices drivingly connected to the rotary output member, and a coupler connected between the rotary input member and each of the prime mover and the electric machine. The method may include, in at least some circumstances, controlling the operating speeds of the prime mover and the electric machine independently of the operating speed of the rotary input member while the coupler accommodates any incompatibilities between the operating speed of the rotary input member and the operating speeds of the prime mover and the electric machine by slipping. The method may also include selectively causing the coupler to slip while transmitting power between the rotary input member and at least one of the prime mover and the electric machine. Additionally, the method may include, when the mobile machine is in motion, changing the drive ratio of the multiple-ratio transmission from a first drive ratio to a second drive ratio. The method may further include, in concert with changing the drive ratio of the multiple-ratio transmission, operating the electric machine to adjust an operating speed of the prime mover toward a synchronous speed for the second drive ratio.

A further disclosed embodiment relates to a power system having a prime mover. The power system may also include an electric machine. Additionally, the power system may include a multiple-ratio transmission having a rotary input member and a rotary output member. The power system may also include a variable-slip coupler connected between the prime mover and the rotary input member. The variable-slip coupler may also be connected between the electric machine and the rotary input member. The power system may further include power-system controls operable to selectively cause the variable-slip coupler to slip while transmitting power between the rotary input member of the multiple-ratio transmission and at least one of the prime mover and the electric machine. The power-system controls may also be configured to, in concert with a change in a drive ratio of the multiple-ratio transmission from a first drive ratio to a second drive ratio, operate the electric machine to adjust the operating speed of the prime mover toward a synchronous speed for the second drive ratio.

### BRIEF DESCRIPTION OF THE DRAWINGS

FIG. 1 is a schematic illustration of one embodiment of a machine having a power system according to the present disclosure; and

FIG. 2 is a flow chart illustrating one method of controlling certain aspects of the operation of a power system according to the present disclosure.

### DETAILED DESCRIPTION

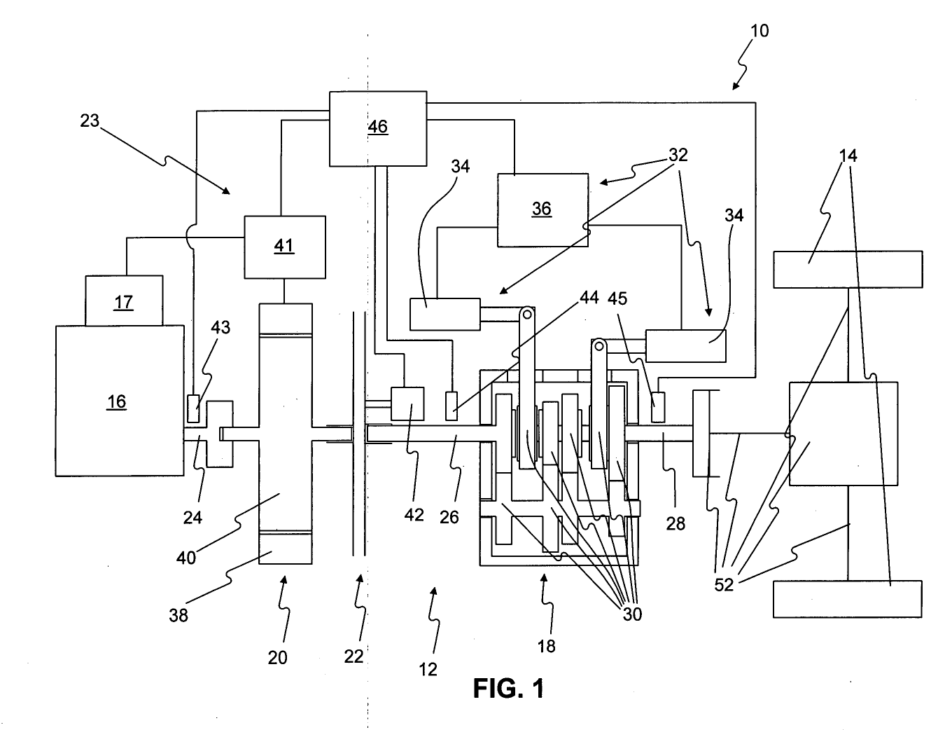

FIG. 1 illustrates one embodiment of a machine 10 having a power system 12 according to the present disclosure. In addition to power system 12, machine 10 may include various components operable to receive power from power system 12 and perform various tasks. For example, as FIG. 1 shows, machine 10 may be a mobile machine having propulsion devices 14 connected to power system 12.

Power system 12 may include a prime mover 16, a multiple-ratio transmission 18, an electric machine 20, a coupler 22, and power-system controls 23. Prime mover 16 may be any type of device operable to provide power by rotating a rotary output member 24. For example, prime mover 12 may be a diesel engine, a gasoline engine, a gaseous fuel driven engine or a gas turbine. Prime mover 16 may include prime-mover controls 17 operable to control various aspects of the operation of prime mover 16. For example, prime-mover controls 17 may be operable to control the rate at which prime mover 16 combusts fuel.

Multiple-ratio transmission 18 may be any system of components that includes a rotary input member 26, a rotary output member 28, and provisions for selectively drivingly connecting rotary input member 26 and rotary output member 28 at one of a plurality of different drive ratios. Multiple-ratio transmission 18 may be configured such that there are a finite set of discrete drive ratios at which the rotary input member 26 may be drivingly connected to rotary output member 28. Alternatively, multiple-ratio transmission 18 may be configured in a manner allowing continuous adjustment of a drive ratio between rotary input member 26 and rotary output member 28.

In addition to rotary input member 26 and rotary output member 28, multiple-ratio transmission 18 may include intermediate power-transfer components 30 and transmission controls 32. Intermediate power-transfer components 30 may include any component or components capable of drivingly connecting rotary input member 26 and rotary output member 28, such as shafts, gears, pulleys and belts, sprockets and chains, and couplers. Transmission controls 32 may include any component or components operable to control whether and at what drive ratio intermediate power-transfer components 30 drivingly connect rotary input member 26 and rotary output member 28. For example, transmission controls 32 may include actuators 34 and a controller 36 collectively operable to automatically control the drive ratio of multiple-ratio transmission 18 by controlling which of intermediate power-transfer components 30 are drivingly connected between rotary input member 26 and rotary output member 28. Multiple-ratio transmission 18 may include or omit synchronizers (not shown) for synchronizing the operating speeds of intermediate power-transfer components 30 during changes in the drive ratio between rotary input member 26 and rotary output member 28.

Multiple-ratio transmission 18 is not limited to the configuration shown in FIG. 1. For example, in some embodiments, such as embodiments where multiple-ratio transmission 18 is a “transaxle,” multiple-ratio transmission 18 may include one or more other rotary output members in addition to rotary output member 28. Additionally, rotary input member 26, rotary output member 28, and intermediate power-transfer components 30 need not be mounted to a common housing or arranged in a compact group as shown in FIG. 1. Furthermore, multiple-ratio transmission 18 may have different configurations of intermediate power-transfer components 30 than shown in FIG. 1.

Additionally, transmission controls 32 may be configured differently than shown in FIG. 1 and discussed above. Transmission controls 32 may be operable to control the drive ratio of multiple-ratio transmission 18 in other manners in addition to, or in place of, controlling which of intermediate power-transfer components 30 is/are connected between rotary input member 26 and rotary input member 28. For example, transmission controls 32 may also be operable to control the drive ratio of multiple-ratio transmission 18 through selective braking of one or more of the intermediate power-transfer components 30, control of the geometry of one or more components of multiple-ratio transmission 18, and/or various other means. Additionally, transmission controls 32 may include other controllers and/or logic systems in addition to, or in place of, transmission controller 36. Alternatively, transmission controls 32 may be operable to enable only manual control of multiple-ratio transmission 18, in which case, transmission controls 32 may omit transmission controller 36. Additionally, transmission controls 32 may include one or more devices for selectively preventing rotation of rotary input member 26 and/or rotary output member 28.

Electric machine 20 may be any type of device operable to operate as an electric motor and/or an electric generator. Electric machine 20 may include a stator 38 and a rotor 40 operable to rotate adjacent stator 38. Additionally, electric machine 20 may include electric-machine controls 41 operable to control the operating state of electric machine 20 by controlling the flow of electricity to and/or from electric machine 20. Rotor 40 may be drivingly connected to rotary output member 24 of prime mover 16. As FIG. 1 shows, rotor 40 may be directly drivingly connected to rotary output member 24 at a 1:1 ratio. Alternatively, additional power-transfer components (not shown) may drivingly connect rotor 40 to rotary output member 24 at a ratio other than 1:1.

Coupler 22 may be connected between rotary input member 26 of multiple-ratio transmission 18 and rotor 40 of electric machine 20 and, thus, between rotary input member 26 and rotary output member 24 of prime mover 16. As FIG. 1 shows, each of rotary input member 26 of multiple-ratio transmission 18, rotor 40 of electric machine 20, and rotary output member 24 of prime mover 16 may connect to coupler 22 at a 1:1 ratio. Alternatively, one or more of these components may connect to coupler 22 through additional power-transfer components at a ratio other than 1:1.

Coupler 22 may be any type of component that may be employed to selectively transmit power between rotor 40 and rotary input member 26. In some embodiments, coupler 22 may be a variable-slip coupler. For example, as FIG. 1 shows, coupler 22 may be a friction clutch. Alternatively, coupler 22 may be another type of variable-slip coupler, such as a torque converter or other fluid coupler, a magnetic clutch, or any other type of coupler operable to transmit power while slipping. Additionally, in some embodiments, coupler 22 may be a selectively-engageable coupler incapable of transmitting power while slipping, such as a dog clutch.

Coupler 22 may include coupler controls 42, which may be operable to directly control whether coupler 22 has a power-transmitting operating state. For example, in embodiments where coupler 22 is a friction clutch, coupler controls 42 may be operable to cause coupler 22 to have a non-power-transmitting operating state by separating its friction elements from one another. Conversely, in such embodiments, coupler controls 42 may cause coupler 22 to have a power-transmitting operating state by pressing its friction elements together. Similarly, in embodiments where coupler 22 is a fluid coupler, coupler controls 42 may be operable to cause coupler 22 to have a non-power-transmitting operating state by draining fluid from coupler 22 and, conversely, to cause coupler 22 to have a power-transmitting operating state by returning fluid to coupler 22.

In some embodiments, coupler 22 may omit coupler controls 42, and the operating state of coupler 22 may depend upon the operation of the components connected to coupler 22. For example, in embodiments where coupler 22 is a fluid coupler with no coupler controls for directly controlling its operating state, the amount of torque transmitted by coupler 22 may depend upon the respective operating speeds of the prime mover 16, electric machine 20, and rotary input member 26 of multiple-ratio transmission 18.

Power-system controls 23 may be any collection of components operable to control the operation of power-system 12. Power-system controls 23 may include prime-mover controls 17, transmission controls 32, coupler controls 42, and a controller 46. Controller 46 may be operable to coordinate control of various components of machine 10. Controller 46 may include one or more processors (not shown) and one or more memory devices (not shown). Controller 46 may be operatively connected to prime-mover controls 17, transmission controller 36, electric-machine controls 41, and coupler controls 42, and controller 46 may be operable to indirectly exercise control over various aspects of the operation of prime mover 16, multiple-ratio transmission 18, electric machine 20, and coupler 22. In some embodiments, controller 46 may be operable to exercise fully automatic control over one or more of prime mover 16, multiple-ratio transmission 18, electric machine 20, and coupler 22. For example, in some embodiments, controller 46 may be operable to automatically control whether rotary input member 26 of multiple-ratio transmission 18 is drivingly connected to rotary output member 24 of prime mover 16 by automatically controlling whether coupler 22 has a power-transmitting operating state.

Power-system controls 23 may also include various sensors. For example, power-system controls 23 may include speed sensors 43, 44, 45 operatively connected to controller 46. Speed sensors 43, 44, 45 may be operable to provide controller 46 with information relating to the speed of rotary output member 24 of prime mover 16, the speed of rotary input member 26 of muliple-ratio transmission 18, and the speed of rotary output member 28 of multiple-ratio transmission 18, respectively.

Power-system controls 23 are not limited to the configuration shown in FIG. 1. For example, in addition to, or in place of controller 46, power-system controls 23 may include various other types of logic systems, including, but not limited to, hardwired logic circuits, hydraulic logic systems, pneumatic logic systems, and mechanical logic systems. Power-system controls 23 may also include other controllers operable to assist controller 46 in coordinating control of the various components of power system 12.

Alternatively, in some embodiments, power-system controls 23 may omit dedicated logic systems for coordinating control of one or more of the components of power system 12 with other components of the power system. Two or more of prime-mover controls 17, transmission controls 32, electric-machine controls 41, and coupler controls 42 may be operable to exchange information and control their respective components in a coordinated manner. Additionally, in some embodiments, two or more of prime-mover controls 17, transmission controls 32, electric-machine controls 41, coupler controls 42, and controller 46 may be integrated. Furthermore, one or more of prime-mover controls 17, transmission controls 32, electric-machine controls 41, and coupler controls 42 may be operable to control their respective components substantially independent of the other components of power system 12. Moreover, in some embodiments one or more of prime mover controls 17, transmission controls 32, electric-machine controls 41, and coupler controls 42 may be configured to allow manual control of their respective components.

Additionally, the general configuration of power system 12 is not limited to that shown in FIG. 1. For example, power system 12 may include various other components, including, but not limited to, additional couplers, additional transmissions, additional power sources, and/or additional power loads connected between rotary output member 24 of prime mover 16 and rotary input member 26 of multiple-ratio transmission 18. Additionally, in some embodiments, coupler 22 may be connected between electric machine 20 and prime mover 16, rather than being connected between electric machine 20 and rotary input member 26 of multiple-ratio transmission 18.

Propulsion devices 14 may include any types of devices operable to propel machine 10 by receiving power from power system 12 and apply that power to the environment surrounding machine 10. For example, as FIG. 1 shows, propulsion devices 14 may include wheels. Additionally, in some embodiments, propulsion devices 14 may include other types of components for propelling mobile machine 10 by applying power to the ground, such as track units. Furthermore, in some embodiments, propulsion devices 14 may include one or more types of devices operable to propel machine 10 by applying power to fluid surrounding machine 10, such as propellers. Propulsion devices 14 may be drivingly connected to rotary output member 28 of multiple-ratio transmission 18, either directly, or, as FIG. 1 shows, through power-transfer components 52. Power-transfer components 52 may be configured to keep propulsion devices 14 and rotary output member 28 continuously connected, or power-transfer components 52 may be operable to selectively decouple propulsion devices 14 from rotary output member 28.

### INDUSTRIAL APPLICABILITY

Machine 10 and power system 12 may have application wherever power is required for performing one or more tasks. During operation of machine 10, power-system controls 23 may receive inputs from various sources and control the components of power system 12 in a coordinated manner to achieve various objectives. For example, propulsion-system controls 23 may effect propulsion of machine 10 by causing rotary input member 26 and rotary output member 28 of multiple-ratio transmission 18 to be drivingly connected while causing prime mover 16 and/or electric machine 20 to transmit power through coupler 22 and multiple-ratio transmission 18 to propulsion devices 14.

When power-system controls 23 are not causing prime mover 16 or electric machine 20 to propel machine 10, power-system controls 23 may, under some circumstances, control the operating speeds of prime mover 16 and electric machine 20 independently of the operating speed of rotary input member 26 of multiple-ratio transmission 18. Coupler 22 may enable controlling the operating speeds of prime mover 16 and electric machine 20 independently of the operating speed of rotary input member 26 by slipping to accommodate incompatibilities between the operating speed of rotary input member 26 and the operating speeds of prime mover 16 and electric machine 20. In embodiments where coupler 22 includes coupler controls 42, controller 46 may cause coupler 22 to have a non-power transmitting operating state so that the operating speeds of prime mover 16 and electric machine 20 may be controlled independently of the operating speed of rotary input member 26.

Additionally, in embodiments where coupler 22 does not include coupler controls 42, coupler 22 may accommodate controlling the operating speeds of prime mover 16 and electric machine 20 independently of the operating speed of rotary input member 26 in various circumstances. For example, in embodiments where coupler 22 is a fluid coupler without coupler controls 42, if transmission controls 32 prevent rotation of rotary input member 26, coupler 22 may slip as necessary to accommodate operation of prime mover 16 and electric machine 20.

Power-system controls 23 may achieve various objectives by controlling the operating speeds of prime mover 16 and electric machine 20 independently of the operating speed of rotary input member 26. For example, under some circumstances, power-system controls 23 may conserve fuel by causing prime mover 16 to be inactive when machine 10 is in motion and rotary input member 26 of multiple-ratio transmission 18 is rotating. Additionally, power-system controls 23 may operate prime mover 16 and electric machine 20 to generate electricity without causing rotary input member 26 to rotate.

Furthermore, in some embodiments and/or some circumstances, power-system controls 23 may control the operating speeds of prime mover 16 and electric machine 20 independent of the operating speed of rotary input member 26 when starting prime mover 16. For example, when starting prime mover 16, power-system controls 23 may operate electric machine 20 as an electric motor to drive prime mover 16 while coupler 22 slips and rotary input member 26 remains stationary. For purposes of this disclosure, “starting” prime mover 16 is considered to be the act of causing prime mover 16 to commence operation under its own power. In some embodiments, starting prime mover 16 entails accelerating rotary output member 24 with an external power source, such as electric machine 20, to a speed sufficient to allow prime mover 16 to commence combusting fuel.

In embodiments where coupler 22 is a variable-slip coupler, power-system controls 23 may also, in various circumstances, operate power system 12 in such a manner that coupler 22 slips while transmitting power between rotary input member 26 and at least one of prime mover 16 and electric machine 20. For example, after starting prime mover 16, power-system controls 23 may gradually launch machine 10 by drivingly connecting rotary input member 26 and rotary output member 28 and causing coupler 22 to slip while transmitting power from prime mover 16 to rotary input member 26.

Different configurations of coupler 22 may require power-system controls 23 to employ different methods of launching machine 10 by causing coupler 22 to slip while transmitting power from prime mover 16 to rotary input member 26. In embodiments where coupler 22 is a friction clutch and coupler 22 includes coupler controls 42, power-system controls 23 may gradually increase the power transfer through coupler 22 by pressing the friction elements of coupler 22 together with increasing force. Alternatively, in embodiments where coupler 22 is a fluid coupler or any other type of device that transmits torque as a function of a speed differential across it, power-system controls 22 may launch machine 10 by gradually increasing the operating speed of prime mover 16 to gradually increase the torque that coupler 22 transmits to rotary input member 26.

In some embodiments and/or circumstances power-system controls 23 may also coordinate control of electric machine 20, coupler 22, and multiple-ratio transmission 18 in such a manner to launch machine 10 while starting prime mover 16. For example, power-system controls 23 may cause rotary input member 26 and rotary output member 28 to be drivingly connected while operating electric machine 22 as an electric motor and causing power transfer through coupler 22. Operating power system 12 in such a manner may cause electric machine 22 to drive rotary output member 24 of prime mover 16 so that prime mover 16 may be started while electric machine 22 also transmits power through multiple-ratio transmission 18 to propulsion devices 14 to launch machine 10. When operating power system 12 in such a manner, in embodiments where coupler 22 includes coupler controls 42, power-system controls 23 may cause coupler 22 to have a power-transmitting operating state. Alternatively, in some embodiments, such as embodiments where coupler 22 is a fluid coupler without coupler controls 42, coupler 42 may automatically transmit power to allow electric machine 20 to simultaneously launch machine 10 and drive rotary output member 24 of prime mover 16.

After launching machine 10, power-system controls 23 may change the drive ratio between rotary input member 26 and rotary output member 28 in response to various circumstances. In response to some circumstances, power-system controls 23 may change the drive ratio between rotary input member 26 and rotary output member 28 from a first drive ratio to a second drive ratio that is lower than the first drive, such that rotary input member 26 rotates more slowly with respect to rotary output member 28. Within this disclosure, such a change in the drive ratio of multiple-ratio transmission 18 is considered an “upshift” of multiple-ratio transmission 18. Conversely, in response to some circumstances, power-system controls 23 may “downshift” multiple-ratio transmission 18 by changing the drive ratio between rotary input member 26 and rotary output member 26 from a first drive ratio to a second drive ratio that is higher than the first drive ratio.

In concert with upshifting or downshifting multiple-ratio transmission 18 from a first drive ratio to a second drive ratio, power-system controls 23 may adjust the operating speed of prime mover 16 toward a synchronous speed for the second drive ratio. The synchronous speed of prime mover 16 for the second drive ratio is equal to the product of the current operating speed of rotary output member 28, the second drive ratio, the drive ratio between coupler 22 and rotary input member 26, and the drive ratio between prime mover 16 and coupler 22. The nearer the operating speed of prime mover 16 is to this synchronous speed, the less coupler 22 will have to slip when the drive ratio between rotary input member 26 and rotary output member 28 is changed to the second drive ratio.

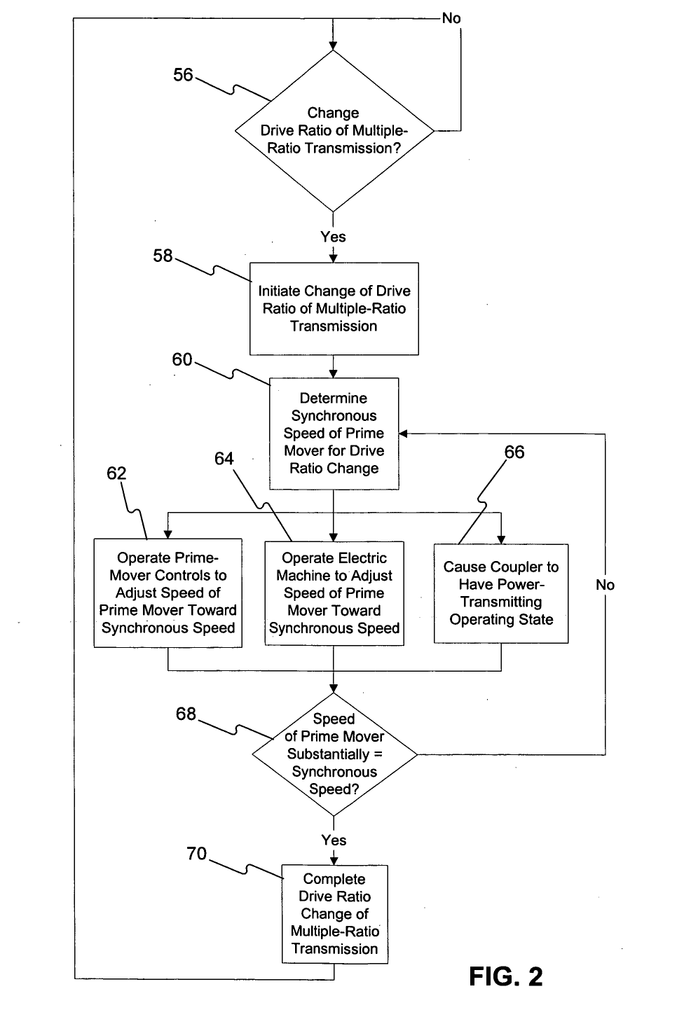

FIG. 2 illustrates one method according to which power-system controls 23 may adjust the operating speed of prime mover 16 in concert with upshifts and downshifts of multiple-ratio transmission 18. When machine 10 is in motion with rotary input member 26 and rotary output member drivingly connected to one another, controller 46 may continuously determine whether to change the drive ratio between rotary input member 26 and rotary output member 28. (step 56) Controller 46 may make this determination based upon various factors, such as, for example, the current drive ratio of multiple-ratio transmission 18, the operating speed of prime mover 16, and/or various inputs from an operator. When controller 46 determines that a drive ratio change of multiple-ratio transmission 18 is appropriate, controller 46 may cause transmission controls 32 to initiate such a change. (step 58) For example, controller 46 may cause transmission controls 32 to decouple rotary input member 26 and rotary output member 28.

After initiating a drive ratio change of multiple-ratio transmission 18, controller 46 may calculate the synchronous speed of prime mover 16 for the drive ratio to which the multiple-ratio transmission 18 will be shifted. (step 60) Controller 46 may do so utilizing information received from one or more of speed sensors 43-45 and/or transmission controls 32. Subsequently, power-system controls 23 may operate prime-mover controls 17 to adjust the operating speed of prime mover 16 toward the synchronous speed (step 62), such as by adjusting the rate at which prime mover 16 combusts fuel. Simultaneously, power-system controls 23 may expedite the adjustment of the operating speed of prime mover 16 by operating electric machine 20 to assist prime-mover controls 17 in adjusting the operating speed of prime mover 16 toward the synchronous speed for the drive ratio change. (step 64) If the drive ratio change is an upshift, the operating speed of prime mover 16 will generally be initially higher than the synchronous speed for the upshift, and power-system controls 23 will operate both prime-mover controls 17 and electric machine 20 to reduce the operating speed of prime mover 16. Power-system controls 23 may cause electric machine 20 to reduce the operating speed of prime mover 16 by, for example, operating electric machine 20 as an electric generator.

If the drive ratio change is a downshift, the operating speed of prime mover 16 will generally be initially higher than the synchronous speed for the downshift, and power-system controls 23 may cause both prime-mover controls 17 and electric machine 20 to increase the operating speed of prime mover 16. Power-system controls 23 may cause electric machine 20 to increase the operating speed of prime mover 16 by operating electric machine 20 as an electric motor to accelerate rotary output member 24.

While adjusting the operating speed of prime mover 16 toward the synchronous speed for the drive ratio change, power-system controls 23 may automatically cause coupler 22 to have a power-transmitting operating state. (step 66) For example, in embodiments where coupler 22 is a friction clutch, power-system controls 23 may cause coupler 22 to be fully engaged. With coupler 22 in a power-transmitting operating state, by adjusting the operating speed of prime mover 16 toward its synchronous speed for the drive ratio change, prime-mover controls 17 and electric machine 20 may also adjust the operating speed of rotary input member 26 toward its synchronous speed for the drive ratio change. The synchronous speed of rotary input member 26 for the drive ratio change may be the product of the current operating speed of rotary output member 28 and the drive ratio to which multiple-ratio transmission 18 is to be shifted.

Until the operating speed of prime mover 16 is substantially equal to the synchronous speed for the drive ratio change (step 68), power-system controls 23 may continue recalculating the synchronous speed and adjusting the operating speed of prime mover 16 toward the synchronous speed while causing coupler 22 to have a power-transmitting operating state. However, when the operating speed of prime mover 16 does become substantially equal to the synchronous speed, power-system controls 23 may complete the change of the drive ratio of multiple-ratio transmission 18. (step 70) For example, controller 46 may cause transmission controls 32 to drivingly connect rotary input member 26 and rotary output member 28 at the new drive ratio. Thereafter, controller 46 may resume determining whether to change the drive ratio of multiple-ratio transmission 18. (step 56)

Methods according to which upshifts and downshifts of multiple-ratio transmission 18 and corresponding adjustments of the operating speed of prime mover 16 may be executed are not limited to the embodiments discussed in connection with FIG. 2. For example, in some embodiments and/or circumstances, power-system controls 23 may only operate electric machine 20 to assist prime-mover controls 17 in adjusting the operating speed of prime mover 16 part way to the synchronous speed for the upshift or downshift. Similarly, in some embodiments power-system controls 23 may only adjust the operating speed of prime mover 16 part way to the synchronous speed for an upshift or downshift. Additionally, power-system controls 23 may cause coupler 22 to have a non-power-transmitting operating state while adjusting the operating speed of prime mover 16. Furthermore, in some embodiments and/or circumstances power-system controls 23 may perform adjustment of the operating speed of prime mover 16 before transmission controls 32 initiate the drive ratio change and/or after transmission controls 32 complete the drive ratio change. Moreover, in embodiments where coupler 22 does not include coupler controls 42, power-system controls 23 may adjust the operating speed of prime mover 16 toward the synchronous speed for an upshift or downshift without exercising direct control over the operating state of coupler 22.

Additionally, rather than power-system controls 23 automatically executing all of the actions shown in FIG. 2, some of the actions may be performed manually by an operator while power-system controls 23 automatically execute the other actions in concert with the operator's actions. For example, an operator may manually upshift or downshift multiple-ratio transmission 18 while power-system controls 23 adjust the operating speed of prime mover 16 in concert with the upshift or downshift. Furthermore, all of the above-described methods of operating machine 10 may be executed completely manually by one or more operators.

The disclosed embodiments may provide a number of performance benefits. Configuring power-system controls 23 to automatically control the operating state of coupler 22 may help make power system 12 easy for an operator to control, thereby contributing to the operator's satisfaction with power system 12. Additionally, configuring power-system control 23 to automatically control the operating state of coupler 22 may promote trouble-free operation of power-system 12 by ensuring coordinated operation of coupler 22 and other components of power system 12.

Operating electric machine 20 to expedite adjustment of the operating speed of prime mover 16 in concert with upshifts and downshifts may facilitate quickly and smoothly resuming power transfer from prime mover 16, through multiple-ratio transmission 18, to propulsion devices 14. Operating electric machine 20 to expedite adjustment of the operating speed of prime mover 16 may be particularly beneficial in concert with an upshift because prime-mover controls 17 may experience particular difficulty in causing rapid reduction of the operating speed of prime mover 16. In many embodiments, prime-mover controls 17 may be operable to cause reductions in the operating speed of prime mover 16 by ceasing power production by prime mover 16 and relying largely or exclusively on friction to decelerate rotary output member 24 and the other moving components of prime mover 16. The friction of prime mover 16, by itself, may provide only very slow reduction in the operating speed of prime mover 16. Accordingly, electric machine 20 may be able to provide a very large improvement in the rate of reduction of the operating speed of prime mover 16 in concert with an upshift of multiple-ratio transmission 18.

Causing coupler 22 to have a power-transmitting operating state while adjusting the operating speed of prime mover 16 in concert with an upshift or downshift may further enhance performance of power system 12. This may facilitate or enable completing the drive ratio change by causing prime mover 16 and electric machine 20 to also adjust the operating speed of rotary input member 26 toward its synchronous speed for the drive ratio change. Additionally, when in a power-transmitting operating state, coupler 22 may automatically transfer power between prime mover 16, electric machine 20, and rotary input member 26 in such a manner to cause prime mover 16 and rotary input member 26 to approach their respective synchronous speeds at similar rates. This may help ensure that the power available for speed adjustment is distributed in the proper proportion to minimize the time required to bring the operating speeds of both prime mover 16 and rotary input member 26 to or close to their respective synchronous speeds for the upshift or downshift.

Additionally, embodiments of power system 12 wherein coupler 22 is a variable-slip coupler may have certain operating advantages. In such embodiments, coupler 22 may enable controlling the operating speeds of prime mover 16 and electric machine 20 independently of the operating speed of rotary input member 26 and, subsequently, gradually initiating power transfer through coupler 22. These capabilities may be beneficial for a number of purposes, such as utilizing electric machine 20 to drive prime mover 16 when starting prime mover 16 and, subsequently, gradually launching machine 10 by causing coupler 22 to slip while transferring power.

It will be apparent to those skilled in the art that various modifications and variations can be made in the disclosed power system and operating methods without departing from the scope of the disclosure. Other embodiments of the disclosed power system and operating methods will be apparent to those skilled in the art from consideration of the specification and practice of the power system and operating methods disclosed herein. It is intended that the specification and examples be considered as exemplary only, with a true scope of the disclosure being indicated by the following claims and their equivalents.

What is claimed is:

1. A power system, comprising:
a prime mover;
a multiple-ratio transmission having a rotary input member and a rotary output member;
a coupler connected between the prime mover and the rotary input member of the multiple-ratio transmission;
an electric machine; and
power-system controls operable to
automatically control whether the rotary input member of the multiple-ratio transmission is drivingly connected to the prime mover, including automatically controlling whether the coupler has a power-transmitting operating state, and
in concert with an upshift of the multiple-ratio transmission from a first drive ratio to a second drive ratio, operate the electric machine to reduce the operating speed of the prime mover.

2. The power system of claim 1, wherein the power-system controls are further operable to
while operating the electric machine to reduce the operating speed of the prime mover, cause the rotary input member of the multiple-ratio transmission to be drivingly connected to the prime mover, including causing the coupler to have a power-transmitting operating state, so that the electric machine also reduces the operating speed of the rotary input member of the multiple-ratio transmission.

3. The power system of claim 2, wherein operating the electric machine to reduce the operating speeds of the prime mover and the rotary input member of the multiple-ratio transmission includes operating the electric machine to reduce the operating speeds of the prime mover and the rotary input member at least until the operating speed of the prime mover is substantially equal to a synchronous speed for the second drive ratio.

4. The power system of claim 2, wherein:
the coupler is a friction clutch; and
causing the coupler to have a power-transmitting operating state while operating the electric machine to reduce the operating speeds of the prime mover and the electric machine includes causing the coupler to be fully engaged.

5. The power system of claim 1, wherein the coupler is connected between the electric machine and the rotary input member of the multiple-ratio transmission.

6. The power system of claim 5, wherein the power-system controls are further operable to
in at least some circumstances, control the operating speed of the prime mover and an operating speed of the electric machine independent of an operating speed of the rotary input member of the multiple-ratio transmission while the coupler accommodates any incompatibilities between the operating speed of the rotary input member and the operating speeds of the prime mover and the electric machine by slipping.

7. The power-system of claim 5, wherein the coupler is operable to transmit power while slipping.

8. The power system of claim 5, wherein the power-system controls are further operable to
in order to start the prime mover, operating the electric machine as an electric motor driving the prime mover while the coupler accommodates any incompatibilities between the operating speed of the rotary input member of the multiple-ratio transmission and the operating speeds of the prime mover and the electric machine by slipping.

9. The power system of claim 8, wherein:
the power system is part of a mobile machine having one or more propulsion devices drivingly connected to the rotary output member of the multiple-ratio transmission; and
the power-system controls are further operable to
subsequent to starting the prime mover, with the rotary input member and the rotary output member of the multiple-ratio transmission drivingly connected, launch the mobile machine by causing the coupler to slip while transmitting power from the prime mover to the rotary input member.

10. The power system of claim 1, wherein:
the power system is part of a mobile machine having one or more propulsion devices drivingly connected to the rotary output member of the multiple-ratio transmission; and
the power-system controls are further operable to coordinate operation of the multiple-ratio transmission, the coupler, and the electric machine to launch the mobile machine while starting the prime mover, including simultaneously
causing the rotary input member and the rotary output member of the multiple-ratio transmission to be drivingly connected,
operating the electric machine as an electric motor while the coupler transmits power, so that the rotary electric machine drives the prime mover to enable starting the prime mover and also drives the propulsion devices through the multiple-ratio transmission to launch the mobile machine.

11. The power system of claim 1, wherein operating the electric machine to reduce the operating speed of the prime mover includes operating the electric machine to reduce the operating speed of the prime mover at least until the operating speed of the prime mover is substantially equal to a synchronous speed for the second drive ratio.

12. The power system of claim 1, wherein the power-system controls are further operable to
in concert with a downshift of the multiple-ratio transmission, operate the electric machine to increase the operating speed of the prime mover.

13. The power system of claim 1, wherein the power system is part of a mobile machine, the mobile machine including one or more propulsion devices drivingly connected to a rotary output member of the multiple-ratio transmission.

14. A method of operating a mobile machine, the mobile machine having a prime mover, an electric machine, a multiple-ratio transmission with a rotary input member and a rotary output member, one or more propulsion devices drivingly connected to the rotary output member, and a coupler connected between the rotary input member and each of the prime mover and the electric machine, the method comprising:
in at least some circumstances, controlling the operating speeds of the prime mover and the electric machine independently of the operating speed of the rotary input member while the coupler accommodates any incompatibilities between the operating speed of the rotary input member and the operating speeds of the prime mover and the electric machine by slipping;
selectively causing the coupler to slip while transmitting power between the rotary input member and at least one of the prime mover and the electric machine;
when the mobile machine is in motion, changing the drive ratio of the multiple-ratio transmission from a first drive ratio to a second drive ratio; and
in concert with changing the drive ratio of the multiple-ratio transmission, operating the electric machine to adjust an operating speed of the prime mover toward a synchronous speed for the second drive ratio.

15. The method of claim 14, wherein controlling the operating speeds of the prime mover and the electric machine independent of the operating speed of the rotary input member includes operating the electric machine as an electric motor to drive the prime mover when starting the prime mover.

16. The method of claim 15, wherein selectively causing the coupler to slip while transmitting power between the rotary input member and at least one of the prime mover and the electric machine includes
subsequent to starting the prime mover, with the rotary input member and the rotary output member of the multiple-ratio transmission drivingly connected, launching the mobile machine by causing the coupler to transmit power from the prime mover to the rotary input member while slipping.

17. The method of claim 14, further including:
while operating the electric machine to adjust the operating speed of the prime mover toward a synchronous speed for the second drive ratio, causing the rotary input member of the multiple-ratio transmission to be drivingly connected to the prime mover, including causing the coupler to have a power-transmitting operating state, so that the electric machine also adjusts the operating speed of the rotary input member toward a synchronous speed for the second drive ratio.

18. The method of claim 14, wherein operating the electric machine to adjust the operating speed of the prime mover toward a synchronous speed for the second drive ratio includes operating the electric machine to adjust the operating speed of the prime mover at least until the operating speed of the prime mover is substantially equal to the synchronous speed for the second drive ratio.

19. The method of claim 14, wherein selectively causing the coupler to slip while transmitting power between the rotary input member and at least one of the prime mover and the electric machine includes
with the rotary output member drivingly connected to the rotary input member, launching the mobile machine by causing the coupler to transmit power from the prime mover to the rotary input member while slipping.

20. The method of claim 14, further including:
selectively coordinating operation of the multiple-ratio transmission, the coupler, and the electric machine to launch the mobile machine while starting the prime mover, including simultaneously
causing the rotary input member and the rotary output member of the multiple-ratio transmission to be drivingly connected,
operating the electric machine as an electric motor while the coupler transmits power, so that the rotary electric machine drives the prime mover to enable starting the prime mover and also drives the propulsion devices through the multiple-ratio transmission to launch the mobile machine.

21. A power system, comprising:
a prime mover;
an electric machine;
a multiple-ratio transmission having a rotary input member and a rotary output member;
a variable-slip coupler connected between the prime mover and the rotary input member, the variable-slip coupler also being connected between the electric machine and the rotary input member; and
power-system controls operable to
selectively cause the variable-slip coupler to slip while transmitting power between the rotary input member of the multiple-ratio transmission and at least one of the prime mover and the electric machine, and
in concert with a change in a drive ratio of the multiple-ratio transmission from a first drive ratio to a second drive ratio, operate the electric machine to adjust an operating speed of the prime mover toward a synchronous speed for the second drive ratio.

22. The power system of claim 21, wherein the power-system controls are further operable to
while operating the electric machine to adjust the operating speed of the prime mover toward the synchronous speed for the second drive ratio, cause the rotary input member to be drivingly connected to the prime mover, including causing the variable-slip coupler to have a power-transmitting operating state, so that the electric machine also adjusts an operating speed of the rotary input member of the multiple-ratio transmission toward a synchronous speed for the second drive ratio.

23. The power system of claim 21, wherein the power-system controls are further operable to
when the prime mover is not operating under its own power, start the prime mover, including
operating the electric machine as an electric motor to drive the prime mover while causing the coupler to slip and the rotary input member of multiple-ratio transmission to be stationary.

24. The power system of claim 23, wherein:
the power system is part of a mobile machine having one or more propulsion devices drivingly connected to the rotary output member of the multiple-ratio transmission; and
causing the variable-slip coupler to slip while transmitting power between the rotary input member of the multiple-ratio transmission and at least one of the prime mover and the electric machine includes
subsequent to starting the prime mover, with the rotary input member and the rotary output member of the multiple-ratio transmission drivingly connected, launching the mobile machine by causing the prime mover to transfer power through the variable-slip coupler to the rotary input member of the multiple-ratio transmission while the variable-slip coupler slips.

25. The power system of claim 21, wherein operating the electric machine to adjust the operating speed of the prime mover toward the synchronous speed for the second drive ratio includes operating the electric machine to adjust the operating speed of the prime mover until the operating speed of the prime mover is approximately equal to the synchronous speed for the second drive ratio.

26. The power system of claim 21, wherein:
the power system is part of a mobile machine having one or more propulsion devices drivingly connected to the rotary output member of the multiple-ratio transmission;
the power-system controls are further operable to coordinate operation of the multiple-ratio transmission, the coupler, and the electric machine to launch the mobile machine while starting the prime mover, including simultaneously
causing the rotary input member and the rotary output member of the multiple-ratio transmission to be drivingly connected, and
operating the electric machine as an electric motor while the coupler transmits power, so that the rotary electric machine drives the prime mover to enable starting the prime mover and also drives the propulsion devices through the multiple-ratio transmission to launch the mobile machine.
